(19) United States
(12) Patent Application Publication
(10) Pub. No.: US 2019/0166827 A1
(43) Pub. Date: Jun. 6, 2019

(54) CRYOPRESERVATION OF CARTILAGE AND OSTEOCHONDRAL TISSUE

(71) Applicant: AlloSource, Centennial, CO (US)

(72) Inventor: Carolyn Barrett Rorick, Denver, CO (US)

(73) Assignee: AlloSource, Centennial, CO (US)

(21) Appl. No.: 16/249,689

(22) Filed: Jan. 16, 2019

Related U.S. Application Data
(63) Continuation-in-part of application No. 15/231,586, filed on Aug. 8, 2016.
(60) Provisional application No. 62/202,661, filed on Aug. 7, 2015.
(60) Provisional application No. 62/218,289, filed on Sep. 14, 2015.
(60) Provisional application No. 62/618,000, filed on Jan. 16, 2018.

(51) Int. Cl. A01N 1/02

(52) U.S. Cl. CPC A01N 1/0278; A01N 1/0284; A01N 1/0221

(57) ABSTRACT

Provided are systems and methods for cryopreserving tissue, particularly cartilage tissue and osteochondral tissue. Also provided are tissue products made using such systems and methods. Certain methods involve combining tissue with a cryopreservation solution in a processing vessel and applying resonant acoustic energy thereto prior to freezing the tissue. The resonant acoustic energy rapidly agitates the tissue with the cryopreservation solution by vibration. By applying resonant acoustic energy to the tissue during processing, the rate or efficiency of processing, or both, may be improved. Certain methods involve soaking tissue in a cryopreservation solution prior to freezing the tissue.

### CROSS-REFERENCE TO RELATED APPLICATIONS

This application is a continuation in part of Ser. No. 15/231,586, filed Aug. 8, 2016, which claims benefit of priority of U.S. Provisional Application No. 62/218,289, filed Sep. 14, 2015, and U.S. Provisional Application No. 62/202,661, filed Aug. 7, 2015. This application also claims benefit of priority of U.S. Provisional Application No. 62/618,000, filed Jan. 16, 2018, each of which are incorporated herein by reference in their entireties.

### BACKGROUND

Fresh cartilage and osteochondral allografts have been used for decades to repair articular cartilage defects. There is a limitation in the use of fresh tissue due to short shelf life and size matched donor requirements. Conventional cryopreservation methods utilize a cryoprotectant and a controlled rate freezer to slow the cooling process in order to prevent ice crystal formation and subsequent cell damage. However, an effective cryopreservation method utilizing conventional techniques remains limited for cartilage and osteochondral allografts due to the fact that the cryoprotective agents cannot successfully penetrate through the tissue. Davidson, A., et al., PLoS ONE 2015, 10(11). There is a need to develop alternative storage procedures to overcome the aforementioned limitations.

### SUMMARY

In one aspect, provided are methods of cryopreserving a tissue that include loading a processing vessel with a tissue and a cryopreservation solution, thereby providing a combination thereof disposed in the processing vessel; applying resonant acoustic energy to the processing vessel, thereby vibrating the processing vessel and the combination disposed therein to form a processed tissue (the tissue mixed with the cryopreservation solution); and freezing the processed tissue to form a cryopreserved tissue.

In another aspect, provided are methods of cryopreserving tissue in which the tissue is placed in a cryopreservation solution and soaked for up 2 hours prior to being placed at freezing temperatures to freeze the tissue, thereby forming a cryopreserved tissue.

In another aspect, provided are processed tissue and tissue products made according to any of the above methods.

In another aspect, provided are systems for processing a tissue according to any of the above methods, the systems including a processing vessel; and a high intensity mixing device that applies acoustic resonance energy to the processing vessel disposed therein.

The above described and many other features and attendant advantages of embodiments of the present disclosure will become apparent and further understood by reference to the following detailed description when considered in conjunction with the accompanying drawings.

### BRIEF DESCRIPTION OF THE DRAWINGS

These figures are intended to be illustrative, not limiting. Although the aspects of the disclosure are generally described in the context of these figures, it should be understood that it is not intended to limit the scope of the disclosure to these particular aspects.

FIG. 1 shows steps in a method of cryopreserving tissue according to some aspects of the present disclosure.

FIG. 2 shows a bar graph illustrating the number of metabolically active cells in tissue grafts before and after cryopreservation using either resonant acoustic wave processing (TEST) or soaking (CONTROL) in cryopreservation medium in accordance with aspects of this disclosure. Data shown reflects the average of three donors for each group, with at least three samples per donor.

FIG. 3A shows outgrowth of viable chondrocytes from a tissue graft cryopreserved in accordance with aspects of this disclosure. This is a representative field showing chondrocytes outgrown onto the well bottom. The image depicted was taken after 3 weeks of recovery post-thawing and 3 weeks of explantation.

FIG. 3B shows a bar graph illustrating the number of cells counted after in vitro culturing of fresh tissue grafts and cryopreserved tissue grafts following a cryopreservation storage time of 6 months time in accordance with aspects of this disclosure. Cell number was counted at 3 weeks, 6 weeks, and 9 weeks. The bar on the left for each time point is the number counted for the fresh grafts, and the bar on the right for each time point is the number counted for the cryopreserved grafts.

FIGS. 4A-4D show expression of Connexin-43 and Collagen II in cartilage grafts post-cryopreservation at 12 weeks post-explantation in accordance with aspects of this disclosure. Confocal microscopy images were taken at 10X. FIG. 4A shows Connexin-43 expression, FIG. 4B shows Collagen II expression; FIG. 4C shows DAPI nuclei staining; and FIG. 4D shows a composite image of FIGS. 4A-3C. In FIG. 4D, there is almost complete overlap in the expression patterns of Connexin-43 and Collagen II.

FIG. 5 shows an exemplary system for processing tissue according to some aspects of the disclosure.

FIG. 6 shows a schematic of an exemplary system for processing tissue for cryopreservation according to some aspects of the disclosure.

FIG. 7 shows cartilage tissue grafts from three different donors stained with alkaline phosphatase, demonstrating the presence of osteoblast cells in accordance with aspects of this disclosure. The image on the right is a non-viable tissue graft stained with AP, serving as a control, displaying the variation in osteogenic activity between viable and non-viable grafts.

FIG. 8 shows calcium mineralization present in a cartilage tissue graft as identified by von Kossa (“VK”) stain in accordance with aspects of this disclosure. The image on the lower left shows a full thickness cross section of a 1 mm graft at 4× magnification with VK staining. The image on the upper right shows the same graft at 40× magnification.

FIG. 9 shows an image of an immunohistochemically stained cartilage tissue graft reflecting the presence of both osteogenic and chondrogenic activity in accordance with aspects of this disclosure.

FIG. 10 shows a graph summarizing viability assessment of cartilage samples cryopreserved in accordance with aspects of this disclosure. Viability assessment was performed using Trypan Blue™ reagent. “RAW” samples were processed with cryopreservation medium using resonant acoustic wave energy. “No RAW” samples were processed with cryopreservation medium by stationary soaking.

### DETAILED DESCRIPTION

Provided herein are methods of cryopreserving cartilage and osteochondral tissue and tissue products produced by such methods. The methods sufficiently load a cryoprotectant agent within the cartilage matrix of the tissue in order to successfully cryopreserve the tissue without compromising cell viability. Cryopreservation of cartilage and osteochondral tissue mitigates the limited shelf life which consistently limits the availability of fresh grafts. The methods provided herein permit a cryoprotectant to breach the depth of the cartilage matrix, displaying no adverse effect toward cell viability. Cryopreserved tissue grafts produced according to the provided methods contain viable, metabolically active cells, reflecting that the original composition of the fresh tissue is maintained throughout cryopreservation process.

In one aspect, the provided methods use resonant acoustic energy to facilitate cryopreservation of tissue containing living cells. Cryopreservation is a process wherein biological material such as cells, tissues, extracellular matrix, organs, or any other biological constructs susceptible to damage caused by unregulated chemical kinetics are preserved by cooling to very low temperatures (typically −40° C. or −80° C.). At low enough temperatures, any enzymatic or chemical activity that might cause damage to the biological material in question is effectively stopped. Cryopreservation methods seek to reach low temperatures without causing additional damage caused by the formation of ice during freezing by freezing the biological material in the presence of cryoprotectant molecules. Traditional cryopreservation methods typically rely on coating the material to be frozen with a the cryoprotectant molecules. The cryoprotectants (also referred to as cryoprotective agents, cryoprotectant agents, and cryopreservatives) protect the biological material from the damaging effects of freezing (such as ice crystal formation and increased solute concentration as the water molecules in the biological material freeze). In some instances, the methods of cryopreservation described herein permit more thorough exposure of the tissue to the cryoprotectant during processing, permitting deeper penetration of the cryoprotectant into tissue, and thereby resulting in increased cell viability of the tissue following cryopreservation and thawing. In some instances, the methods provided herein produce processed tissue that retains at least two fold greater cell viability after freezing and thawing. In some instances, the processed tissue retains at least 40%, 45%, 50%, 55%, 60%, 65%, 70%, 75%, 80%, 85%, 90% or 95% cell viability after freezing and thawing as determined by the cell count in the tissue before processing and cell count in the tissue after freezing and thawing. In one example, the processed tissue retains at least 50% cell viability as compared to the tissue before processing.

It has been discovered that vibration caused by resonant acoustic energy provides a useful, effective, and surprisingly efficient alternative to traditional mechanical impeller agitation or ultrasonic mixing. Resonant acoustic energy may be used to apply low acoustic frequencies and high energy to a mechanical system, which in turn is acoustically transferred to a processing vessel placed within the system. The system operates at resonance and therefore there is a near-complete exchange of energy from the mechanical system to the contents of the processing vessel, and only the contents of the processing vessel absorb energy. The acoustic energy can create a uniform shear field throughout the processing vessel, resulting in rapid dispersion of material. The acoustic energy can introduce multiple small scale intertwining eddies throughout the contents of the processing vessel. As compared with traditionally-used mechanical impeller agitation, resonant acoustic processing mixes by creating microscale turbulence, rather than mixing through bulk fluid flow. Similarly, as compared with traditionally used ultrasonic agitation (such as sonication), resonant acoustic processing uses magnitudes lower frequency of acoustic energy, and enables a larger scale of mixing. An exemplary resonant acoustic vibration device is a Resodyn LabRAM ResonantAcoustic® Mixer (Resodyn Acoustic Mixers, Inc., Butte, Mont.). In some instances, the resonant acoustic vibration device may be devices such as those described in U.S. Pat. No. 7,866,878 and U.S. Patent Application No. 2015/0146496, which are incorporated by reference herein in their entirety.

The resonant acoustic energy may increase the rate or efficiency of processing, or both, and the methods may produce products having improved characteristics over tissue products made using conventional methods. Within the processing vessel, resonant acoustic energy applied through resonant acoustic vibration can facilitate the movement of a liquid into and/or throughout tissue. The vibration of resonant acoustic energy may enhance the rate of interaction between tissue and processing solution. The application of resonant acoustic energy may also be effective in increasing the reaction kinetics or mass transfer kinetics of certain tissue processing techniques such as, for example, demineralization or decellularization. As a result, the rate of tissue processing may be increased as compared to typical tissue processing methods that do not use resonant acoustic energy. The application of resonant acoustic energy to a combination of tissue and processing solution may increase the yield in the production process. In some instances, the methods may provide at least one of more uniform, customized, or predictable processed tissues. For instance, the methods disclosed herein may be used to process tissue regardless of its size and shape to produce a processed tissue and, ultimately, a medical graft, that is more uniform in size and composition, among other qualities. In some instances, use of resonant acoustic energy may permit tissue to be processed without the use of harsh conditions that may impact viability of native cells (cells in the tissue) in the long term, such as in a final graft product. In some instances, use of resonant acoustic energy may permit tissue processing to be performed using less harsh conditions or using reduced amounts of reagents, such as expensive reagents or reagents that could impair cell viability long term.

In one aspect, provided is a method of cryopreserving a tissue, the method comprising loading a processing vessel with a tissue and applying resonant acoustic energy to the processing vessel, thereby vibrating the processing vessel and the tissue disposed therein to form a processed tissue. There are multiple factors impacting tissue processing including, but not limited to, the type of tissue, the amount of time that resonant acoustic energy is applied to the tissue (including any of the total amount of time, the amount of time for any given application, and the intervals of time for a series of applications), the intensity of the resonant acoustic energy for any given application, the frequency of the resonant acoustic energy for any given application, the temperature of the system or at which the tissue is maintained during processing, and the machine used to apply the resonant acoustic energy. These factors influence each other and may be selected to influence the properties of the resulting processed tissue including but not limited to the yield of processed tissue, cell or tissue viability, and tissue structural integrity, and the overall processing rate. The methods of cryopreserving tissue include adding at least one of a cryopreservation solution to the processing vessel with the tissue. In some instances, the tissue placed in the processing vessel is one or more intact portions of tissue. In certain instances, the tissue placed in the processing vessel may be homogenized tissue and the method produces a homogenized tissue product.

The methods of this disclosure may be applied to a variety of types of tissue including, but not limited to, bone, tendon, skin, cartilage, osteochondral, fascia, muscle, nerves, vascular tissue, birth, and adipose tissue. In some instances, the tissue used for processing is obtained from a deceased donor. In some instances, the tissue used for processing is obtained from a living donor. In some embodiments, the cartilage tissue is from a human adult cadaveric donor age 15 years or older. For example, the donor may be 15 years to 39 years of age. In another example, the donor may be 16 years to 35 years of age. In particular, this disclosure relates to methods of cryopreserving cartilage tissue and osteochondral tissue.

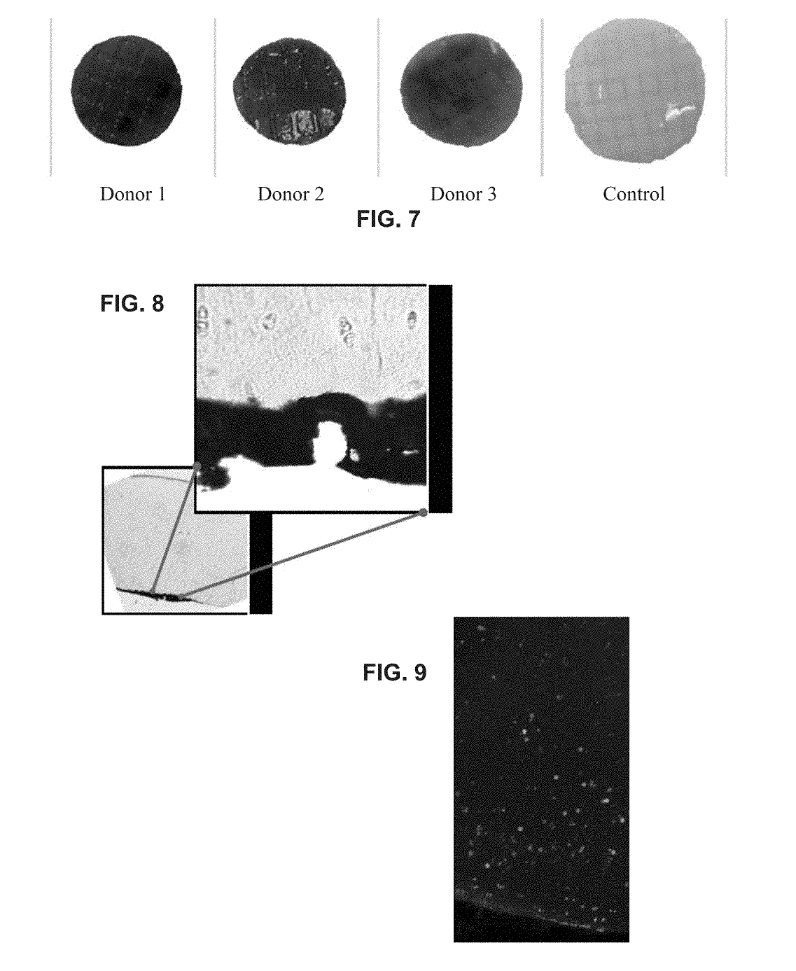

In one embodiment, the tissue is cartilage tissue. In one example, such tissue may be cartilage tissue prepared as described in U.S. Pat. No. 9,186,253 (8 mm×1 mm thick disks, laser etched with square pattern). The tissue for such cartilage grafts is generally shaved off the bone. As a result, as discussed below in Example 1, part A, cartilage grafts made from such tissue may have bone cells present, though visually they do not appear to have bone. For example, such grafts may have osteogenic activity as reflected by alkaline phosphatase (AP) staining as shown in FIG. 7, can produce mineral deposition detectable by Von Kossa stain as shown in FIG. 8., and express Osteopontin as shown in FIG. 9. While such grafts could be considered osteochondral grafts due to the presence of osteoblasts, surgeons that are familiar and work with tissue grafts would generally consider such grafts to be cartilage tissue grafts in view of their appearance (i.e. as a thin sheet of cartilage visually lacking bone tissue attached). As such, such grafts are referred to as cartilage tissue grafts generally and in this disclosure and would be expected to have similar properties in the context of the instant disclosure as if there were no bone cells present.

In another embodiment, the tissue may be osteochondral tissue, which comprises articular cartilage adhered to subchondral bone. The bone portion of such grafts may be configured through cutting to various depths and into various shapes. Exemplary osteochondral grafts are described in U.S. Pat. No. 9,168,140, which is incorporated herein in its entirety for all purposes.

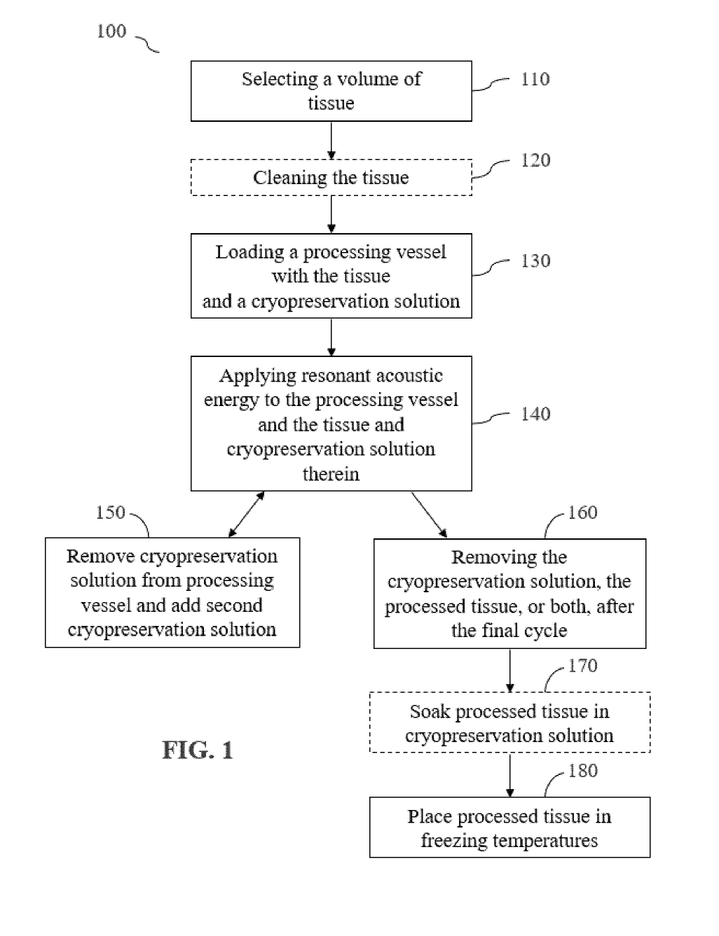

FIG. 1 shows exemplary method 100 for cryopreserving tissue according to one aspect of the present disclosure. The method 100 may include step 110 of selecting a volume of tissue for cryopreservation. In some instances, the tissue is cartilage tissue. In some instances, the tissue is osteochondral tissue. The provided methods are suitable for cryopreservation of a range of tissue sizes. For instance, the tissue can be cartilage sheets or disks. In one example, cartilage tissue as described in U.S. Pat. Nos. 9,186,253 and 9,700,415 and U.S. Patent Appl. No. 20180078375 may be cryopreserved using the provided methods. For example, the cartilage tissue may be 7 mm to 20 mm diameter disks having a thickness of 1 mm. In some instances, the cartilage tissue may have a volume of 38-314 mm³. For example, the cartilage tissue may have a volume of 40 mm³, 50 mm³, 60 mm³, 70 mm³, 80 mm³, 90 mm³, 100 mm³, 120 mm³, 140 mm³, 160 mm³, 180 mm³, 200 mm³, 220 mm³, 240 mm³, 260 mm³, 280 mm³, 300 mm³, 320 mm³, 340 mm³, 360 mm³, 380 mm³, or 400 mm³, or a volume within 50-10% of any of these volumes. In some instances, the osteochondral tissue may be in the shape of a sheet, a dowel, an irregular shape configured to fit an osteochondral defect site of a subject, a talus, a portion of a condyle, or a whole condyle. For example, osteochondral tissue as described in U.S. Pat. Nos. 9,168,140 and 9,603,710 may be cryopreserved using the provided methods. In another example, a dowel of osteochondral tissue may be 7 to 20 mm in diameter and have a layer of cartilage 1-3 mm thick. In some instances, the osteochondral tissue as described in U.S. Pat. No. 8,608,801 and U.S. Patent Application No. 20170056181 may be cryopreserved using the provided methods. Osteochondral tissue for cryopreservation using the provided methods can be of a wide range of volumes such as, for example, 30 mm³-20,000 mm³. Exemplary volumes include 30 mm³-300 mm³, 50 mm³-500 mm³, 100 mm³-500 mm³, 200 mm³-600 mm³, 400 mm³-1000 mm³, 1000 mm³-3000 mm³, 1000 mm³-5000 mm³, 2000 mm³-9000 mm³, 5000 mm³-10000 mm³, 7000 mm³-12000 mm³, 10000 mm³-15000 mm³, 12000 mm³-20000 mm³. In some instances, an osteochondral dowel can a volume of 38 to 942 mm³. The size of some osteochondral tissue will be determined by the original tissue size of the donor. For example, a talus is typically 1000 mm³ to 3500 mm³, a portion of a condyle typically ranges from 2000 mm³ to 8500 mm³, and a whole condyle can range from 5000 mm³ to 20000 mm³.

Optionally, the method may include step 120 of cleaning the tissue to remove blood and other biological fluids or particulates. In some instances, the tissue may be cleaned using systems and methods as described in U.S. Pat. Nos. 7,658,888; 7,776,291; 7,794,653; 7,919,043; 8,303,898; and 8,486,344, each of which are incorporated herein by reference in their entireties. In some embodiments, the cleaning is performed using conventional cleaning techniques, such as the standard cleaning protocol of the American Association of Tissue Banks (AATB). Other conventional methods of cleaning tissue or tissue graft products may also be used. In some instances, the method 100 may include step 120 of cleaning the selected volume of tissue.

The method 100 also includes step 130 of loading a processing vessel with the tissue and a cryopreservation solution. The processing vessel is generally sealed to maintain the combination of the cryopreservation solution and tissue therein.

In the context of this disclosure, a processing vessel includes any container or vessel that can be sealed to maintain the processing solution and tissue inside of the processing vessel and sustain acoustic resonance energy of up to 100 G while maintaining the integrity of the vessel and the seal. Examples include vessels made of non-reactive plastic or resin, metal, or glass. In some embodiments, the processing vessel is disposable. In some embodiments, the processing vessel is jacketed to accommodate cooling or heating. In some embodiments, the processing vessel is sealed with vacuum processing. In the context of this disclosure, loading means placing a tissue and a processing solution into a processing vessel. The processing vessel is sealable (e.g., aseptically or air tight) so as to contain contents therein when resonant acoustic energy is applied. An exemplary processing vessel may be a lidded vessel capable of holding a volume of up to 3,000 mL.

The cryopreservation solution used in the described methods includes a cryoprotectant (cryoprotective) agent. Exemplary cryoprotectant agents include, for example, dimethyl sulfoxide (DMSO), methanol, butanediol, propanediol, polyvinylpyrrolidone, glycerol, hydroxyethyl starch, alginate, and glycols, such as, for example, ethylene glycol, polyethylene glycol, propylene glycol, and butylene glycol. In some instances, combinations of more than one cryoprotectant agent may be used. In one example, the cryopreservative solution may include 6 mol ethyene glycol I-1 and 1.8 mol glycerol I-1. In some instances, the cryoprotectant may be a compound that aids in dehydration (e.g., sugars) or formation of a solid state (e.g., polymers, complex carbohydrates). In some instances, the cryopreservation solution may contain 5% to 30% of a cryoprotectant, or combination of cryoprotectants, in a buffer solution such as cell culture medium. In some instances, the cryopreservation solution may comprise serum or platelet rich plasma, or both, and one or more cryoprotectants. For example, the cryopreservation solution may comprise cell culture medium containing 5-40%, 10-20%, or 10-30% DMSO. In some instances, the cryopreservation solution may contain 5%, 10%, 15%, 20%, 25%, 30%, 35%, or 40% DMSO. In some instances, the cryopreservation solution contains 20% DMSO. In some instances, where a plurality of cryopreservation solutions are used in the method, cryopreservation solutions with different amounts of DMSO may be used at different steps. The concentration of cryoprotectant in the cryopreservation solution may also vary depending on the type or size of tissue being cryopreserved. For example, larger pieces of tissue can be processed with higher concentrations of cryoprotectant.

In some instances, the volume of cryopreservation solution used in the processing vessel can be of sufficient volume that the tissue in the processing vessel is submerged. The volume and/or size of tissue selected for processing is limited by the capacity of the processing vessel. Thus, larger processing vessels are required for processing of larger pieces of tissue and longer pieces of tissue. As the size of the processing vessel increases, the volume of tissue and cryopreservation fluid that it can hold increases. In some examples, the volume of cryopreservation solution may be between 10 mL and 2,400 mL. For example, the volume of cryopreservation solution may be 10 mL, 20 mL, 30 mL, 40 mL, 50 mL, 60 mL, 70 mL, 80 mL, 90 mL, 100 mL, 200 mL, 300 mL, 400 mL, 500 mL, 600 mL, 700 mL, 800 mL, 900 mL, 1 L, 1.1 L, 1.2 L, 1.3 L, 1.4 L, 1.5 L, 1.6 L, 1.7 L, 1.8 L, 1.9 L, 2.0 L, 2.1 L, 2.2 L, 2.3 L. 2.4 L, or another volume within the range of 10 mL to 2,400 L. In some instances, the volume of the cryopreservation solution may be determined by the weight or volume of tissue to be processed. In other instances, the weight or volume of tissue to be processed may be determined by the volume of the cryopreservation solution. In some instances, the ratio of the tissue to cryopreservation solution may be between 100 mL:2 g to 100 mL:6 g. In some instances, the ratio is at least 100 mL:6 g. In some instances, where the tissue is cartilage tissue or osteochondral tissue, the ratio of tissue volume to processing solution may be from 1:10 to 1:1. In some embodiments, the tissue may have a volume of 1 cc to 500 cc and the cryopreservation solution may have a volume of 10 mL to 500 mL. In some instances, the ratio of tissue surface area to processing solution volume is 2500 mm² of surface area per 100 ml processing solution. In some instances, the ratio of cartilage surface area to processing solution volume, for either cartilage tissue alone or osteochondral tissue, is 2500 mm² of cartilage surface area per 100 ml processing solution. The volume of tissue may be increased if the volume of processing solution is increased proportionally.

Method 100 may further include step 140, in which a resonant acoustic field (acoustic resonance) is applied to the processing vessel and the combination of tissue and processing solution therein for a duration of time 140. Step 140 may be repeated a plurality of times. Each application of resonant acoustic energy to the tissue may be considered one cycle. In some instances, when step 140 is repeated (such as when method 100 comprises multiple cycles), step 150 of removing the cryopreservation solution in the processing vessel and replacing it with a second cryopreservation solution may be performed. In some instances, the second cryopreservation solution is the same as the cryopreservation solution placed in the processing vessel in step 130. In some instances, the second cryopreservation solution may be a cryopreservation solution having one or more different properties or components as compared to the cryopreservation solution placed in the processing vessel in step 130. The volume of the second cryopreservation solution may be equivalent to, greater than, or less than the volume of the cryopreservation solution placed in the processing vessel in step 130. Where the method comprises applying the resonant acoustic energy to the processing vessel and combination therein multiple times, step 150 may be performed between each cycle.

Exemplary equipment for performing step 140 of applying a resonant acoustic energy includes a Resodyn LabRAM™ Resonant Acoustic Mixer (Resodyn Acoustic Mixers, Inc., Butte, Mont.). In some instances, the equipment used to apply the resonant acoustic energy may include systems and devices such as described in U.S. Pat. No. 7,866,878 and U.S. Patent Application No. 2015/0146496, which are incorporated by reference herein in their entirety.

In one aspect, the resonant acoustic energy has an intensity (acceleration) and a frequency and is applied for at least one period of time. In some embodiments, the intensity of the resonant acoustic field and the duration of time it is applied may be selected based on the data set forth in Table 1, which is a data set described in International Patent Appl. No. PCT/US2016/046070, published as WO2017027481 (see Example 2, Table 9), which is incorporated herein by reference in its entirety for all purposes. The experiment assess cell viability of cartilage tissue (38 mm×1 mm disks prepared as described in U.S. Pat. No. 9,186,253, which is incorporated herein by reference in its entirety for all purposes) processed in human chondrocyte growth medium in a LabRAM™ II ResonantAcoustic® Mixer (Resodyn, Butte, Mont.) at various settings for different amounts of time as set forth in Table 1 (frequency: 60 Hz). Cell viability of the samples before and after processing was assessed using Presto Blue® assay. Tissue samples for which the cell count of the processed sample remained about the same as the original cell count (no impact on cell viability) are denoted with “+++”. Samples for which the cell count of the processed sample reflected a decrease of 50% or less compared to the original cell count are denoted by “+”. Samples that reflected a greater than 50% reduction in cell viability after processing are denoted by “−”.

TABLE 1
Chondrocyte Cell Viability

| | | | | 25 | 30 | 35 | 40 | 45 |
|---|---|---|---|---|---|---|---|---|
| | 10 min. | 15 min. | 20 min. | min. | min. | min. | min. | min. |
| 10G | +++ | +++ | +++ | +++ | +++ | +++ | +++ | +++ |
| 20G | +++ | +++ | +++ | +++ | +++ | +++ | +++ | +++ |
| 30G | +++ | +++ | +++ | +++ | +++ | +++ | +++ | +++ |
| 40G | +++ | +++ | +++ | +++ | +++ | +++ | +++ | +++ |
| 50G | +++ | +++ | +++ | +++ | +++ | +++ | +++ | + |
| 60G | +++ | +++ | +++ | + | + | + | + | + |
| 70G | + | + | + | − | − | − | − | − |
| 80G | + | + | − | − | − | − | − | − |
| 90G | − | − | − | − | − | − | − | − |
| 100G | − | − | − | − | − | − | − | − |

In some instances, the frequency may be between 15 Hertz and 60 Hertz. In some instances, the frequency may be 15 Hz, 20 Hz, 25 Hz, 30 Hz, 35 Hz, 40 Hz, 45 Hz, 50 Hz, 55 Hz, or 60 Hertz. In some instances, the frequency is 60 Hertz. This is unlike ultrasonics that operate at a frequency above 20 kHz, which can be especially harmful to cellular and biological components. In the provided methods, resonant acoustic energy is applied to a processing vessel (and, thus, the contents therein) and the entire vessel and contents are vibrated at a resonating frequency of up to about 60 Hz, which is substantially below ultrasonic frequencies. Low frequency acoustic waves are efficiently propagated through media (solids and liquids) as described above. In addition, the resonance force exerted on the materials during application of the resonant acoustic energy is many times the force of gravity and is uniformly distributed throughout the materials in the vessel. This results in the unexpected results of rapid and improved penetration of cryoprotective agents into the tissue.

In some instances, the intensity (acceleration) may be between 10 and 100 times the energy of G-Force (10 G to 100 G). In some instances, the resonant acoustic energy may exert up to 100 times the energy of G-Force on the processing vessel and combination. For example, the intensity may be between 10 and 60 times the energy of G-Force (10 G to 60 G). In another example, the intensity may be between 10 and 70 times the energy of G-Force (10 G to 70 G). In another example, the intensity may be between 40 and 70 times the energy of G-Force (40 G to 70 G). In another example, the intensity may be between 40 and 60 times the energy of G-Force (40 G to 60 G). In some instances, the acoustic resonant energy may be applied for 10 minutes at 10-60 G, for 15 minutes for 10-60 G, for 20 minutes at 10-60 G, for 25 minutes at 10-50 G, for 30 minutes at 10-50 G, for 35 minutes at 10-50 G, for 40 minutes at 10-50 G, for 45 minutes at 10-40 G, or for 50-60 minutes at 10-40 G. In another example, the intensity may be between 60 and 100 times the energy of G-Force (60 G to 100 G) if the temperature of the processing vessel and the combination of the processing solution and tissue therein is maintained at no greater than about 37° C. For example, the temperature may be maintained between 4° C. and 37° C. In some instances, if the temperature of the processing vessel and combination therein is maintained at no greater than about 37° C., the intensity may be between 60 and 80 times the energy of G-Force (60 G to 80 G). In some instances, the intensity of the resonant acoustic energy may be modulated during the period of time it is applied to the processing vessel and combination therein such that the resonant acoustic energy has a sequence of a plurality of intensities during the period of application. In some instances, where maintaining cell viability or tissue integrity is not a criteria for the processed tissue, the intensity may be between 60 and 100 times the energy of G-Force (60 G to 100 G) even if the temperature of the processing vessel and the combination of the processing solution and tissue therein rises above 37° C. In some instances, the temperature of the processing vessel and combination therein is maintained below 50° C. In general, temperatures of 50° C. and above may result in significant cell death as proteins typically begin to denature at this temperature. In view of this, methods in which the temperature of the processing vessel and combination therein reach temperatures at or above 50° C. are provided but the processing time (length of time that the resonant acoustic energy is applied) may be limited to shorter time periods, such as, for example, no more than 10 minutes.

In some instances, where the tissue is cartilage or osteochondral tissue, the intensity of the resonant acoustic energy may be 10 G to 70 G and applied for up to about 10 min at a time. In certain instances, where the tissue is cartilage or osteochondral tissue, the intensity of the resonant acoustic energy may be 10 G to 50 G and applied for up to about 45 min at a time.

The resonant acoustic energy is applied to the processing vessel and the combination therein for at least one period of time. In some instances, period of time may be 1 second, 2 seconds, 5 seconds, 10 seconds, 20 seconds, 30 seconds, 1 minute, 5 minutes, 10 minutes, 15 minutes, 20 minutes, 25 minutes, 30 minutes, 35 minutes, 40 minutes, 45 minutes, or a period of time within 5% of any of these time periods. In some instances, the period of time is between 1 minute and 4.5 hours. In some instances, the resonant acoustic energy is applied only one time to the processing vessel and combination therein. In other instances, the resonant acoustic energy is applied a plurality of times (such as in plurality of cycles). In some instances, where the resonant acoustic energy is applied a plurality of times, the total amount of time that the resonant acoustic field may be between 1 minute and 4.5 hours. In some instances, the resonant acoustic energy may be applied to the processing vessel and the combination therein at least one time, at least twice, at least three times, at least four times, or at least five times. In some instances, the resonant acoustic energy is applied no more than twice, three times, four times, or five times.

The method 100 further includes step 160 of removing one or both of the cryopreservation solution (or the second processing solution; not shown) or the processed tissue after the final application of resonant acoustic energy (cycle). In some instances, the processed tissue may be further incubated for a period of time with additional cryopreservation solution (e.g., the cryopreservation solution used in step 130 or step 150 or a cryopreservation solution having one or more different properties or components as compared either such solution).

Subsequently, step 180 may be performed to place the processed tissue in freezing temperatures to freeze the tissue. Generally, the processed tissue is placed in a cryopreservation solution for long term storage at freezing temperatures. Typically, the processed tissue is frozen at −80° C. Freezing is done at a controlled rate to maximize cell viability. For example, a controlled rate freezing apparatus may be used in which the temperature is decreased approximately 1° C. per minute. In another example, cryo-containers containing the processed tissue and cryopreservation solution can be placed in an isopropanol chamber and stored at −80° C. for a minimum of 2-3 hours. In some instances, the cryopreserved tissue is maintained at −80° C. for long term storage. In some instances, the cryopreserved tissue may be transferred to −120° C. for long term storage. The cryopreservation solution can include any of the cryoprotective agents described above. In some instances, the cryopreservation solution for storage includes nutrients or nutritive components, such as a cell culture medium, serum, a buffered solution, a saline solution, water, an antibiotic, a cryoprotectant, or a combination thereof. In some instances, the cryopreservation solution may contain 10% to 30% of a cryoprotectant, or combination of cryoprotectants, in serum or a buffer solution such as cell culture medium. In some instances, the cryopreservation solution includes serum or platelet rich plasma, or both, and one or more cryoprotectants. In some instances, the cryopreservation solution includes serum and one or more cryoprotective agents. For example, the cryopreservation solution can include serum containing 5-40%, 10-20%, or 10-30% DMSO. In some instances, the cryopreservation solution may contain 5%, 10%, 15%, 20%, 25%, 30%, 35%, or 40% DMSO. In some instances, the cryopreservation solution contains 10% DMSO. In some instances, the cryopreservation solution contains 20% DMSO. The concentration of cryoprotectant in the cryopreservation solution may also vary depending on the type or size of tissue being cryopreserved. In some instances, larger pieces of tissue can stored in cryopreservation solution with higher concentrations of cryoprotectant and smaller pieces of tissue can stored in cryopreservation solution with lower concentrations of cryoprotectant. In one example, cartilage tissue can be stored in a cryopreservation solution that includes 10% DMSO in serum. In another example, osteochondral tissue having a volume of up to 1000 mm³ can be stored in a cryopreservation solution that includes 10-20% DMSO in serum. In another example, osteochondral tissue having a volume of 1000 mm³ or more can be stored in a cryopreservation solution that includes 20% DMSO in serum. Once frozen, the cryopreserved tissue can then be packaged as is suitable for storage and shipping.

Optionally, step 170 may be performed in which the processed tissue is soaked in a cryopreservation solution for a period of time before step 180. Alternatively, optional step 170 may be performed before the tissue is placed into the processing vessel. In either scenario, the tissue may be soaked for up to 2 hours in a cryopreservation solution prior to processing or being placed at freezing temperatures. For example, the tissue may be soaked for 5 min, 10 min, 15 min, 20 min, 25 min, 30 min, 40 min, 50 min, 60 min, 75 min, 90 min, 120 min, or an amount of time otherwise less than 2 hours. In some instances, the tissue may be soaked at room temperature or at refrigerated temperatures (4° C.). In some instances, the tissue is agitated on an orbital shaker, a rocker, or a stir plate (with magnetic stirrer in vessel containing tissue and cryopreservation solution) while be soaked. In some instances, the cryopreservation solution is sonicated while the tissue is being soaked therein (continuously, for a portion of the soaking period, or intermittently during the soaking period).

In some instances, the fresh tissue, the processed tissue, the cryopreserved tissue, or a combination thereof, are assessed for viable cells. For example, the viability of cells in the tissue may be assessed metabolically using reagents such as Presto Blue® reagent or MTT. In some instance, Trypan Blue® can be used to assess cell viability. In some instances, the processed tissue is frozen for a period of time (such as at least one week), then thawed, and then assessed for cell viability.

In one aspect, provided in this disclosure are cryopreserved tissues (also called processed tissue composition, processed tissue, graft, composite graft, tissue graft, graft, or tissue)—particularly, cartilage and osteochondral tissue—made using the methods described herein. Such cryopreserved tissues are useful for implantation into a subject such as at a tissue defect site. The cryopreserved tissues provided herein have improved characteristics over comparable cryopreserved tissues made using conventional, known methods. In some instances, the cryopreserved tissues have increased cell viability. In some instances, the cryopreserved tissue comprises an increased proportion of viable native cells as compared to tissue preserved using standard cryopreservation methods. Without being bound to any particular theory, the methods of cryopreservation described herein may permit more thorough exposure of the tissue to the cryoprotectant during processing by permitting deeper penetration of the cryoprotectant into tissue, thereby resulting in increased cell viability of the tissue following cryopreservation and thawing. In some instances, the cryopreserved tissue retains at least two fold greater cell viability after freezing and thawing. In some instances, the processed tissue retains at least 40%, 45%, 50%, 55%, 60%, 65%, 70%, 75%, 80%, 85%, 90% or 95% cell viability after freezing and thawing as determined by the cell count in the tissue before processing and cell count in the tissue after freezing and thawing. In one example, the cryopreserved tissue retains at least 50% cell viability as compared to the tissue before processing. See, for example, International Patent Appl. No. PCT/US2016/046070, published as WO/2017/027481, which is incorporated herein by reference in its entirety for all purposes.

In some instances, the cartilage or osteochondral tissue is processed in a 20% DMSO+80% cell culture medium and at 30 G intensity and 60 Hz frequency for 30-45 min. In some instances, after processing, the tissue samples may be cryopreserved in 10%-20% DMSO+FBS for at least 3 months. The cell viability of the starting cartilage tissue and the cryopreserved tissue may be assessed, such as by using a metabolic activity assay. In some embodiments, processing tissue using the described method may significantly increase the viability of the cryopreserved tissue as compared to the control tissue. In some instances, there may be at least about a two-fold increase in cell viability for the described methods using resonant acoustic energy as compared to controls cryopreserved using convention cryopreservation methods. Without being held to any particular theory, in some instances, the increase in cell viability of tissue samples cryopreserved using the described methods may be due to the ability of resonant acoustic energy to drive the cryoprotectant into the matrix of the tissue thereby protecting cells that would otherwise be more susceptible to the negative impact of freezing and be destroyed or severely weakened. In embodiments, tissue cryopreserved as described may comprise at least 40% of the original viable cells upon thawing and culturing.

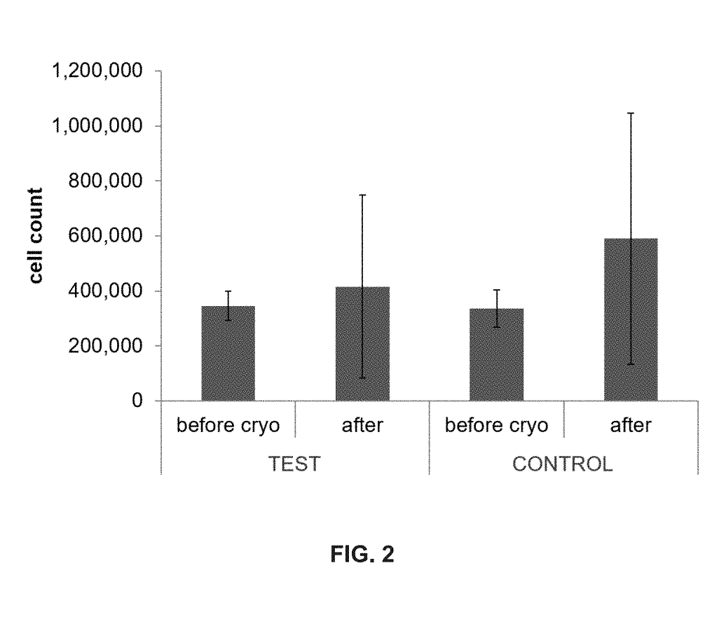

In some instances, cartilage or osteochondral tissue cryopreserved according to the describes methods maintains viable, metabolically active chondrocytes following thawing and culturing in vitro. In some instances, the tissue may be processed with cryopreservation solution (e.g., 20% DMSO in medium) using resonant acoustic energy for 30 to 45 minutes at 30 G and retain about 45% to 85% viability as described in Example 1 and shown in Table 2. In certain instances, processing of tissue for cryopreservation as described in Example 1 and shown in FIG. 2 may yield a more consistent percent viability in the thawed and cultured tissue as compared to tissue cryopreserved by standard methods.

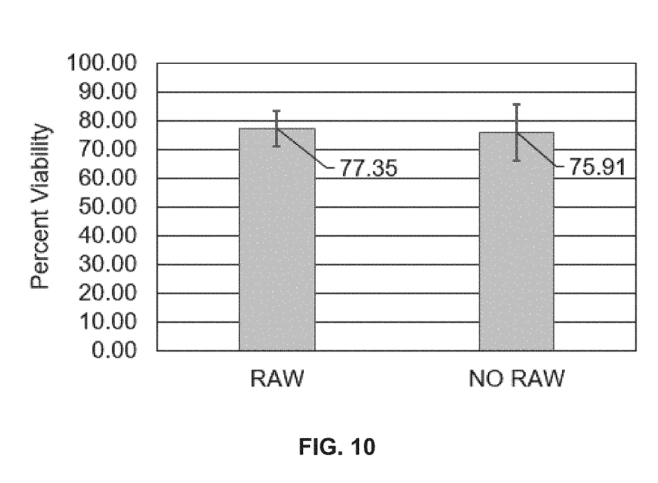

In some instances, cartilage tissue incubated with cryopreservation solution (e.g., 20% DMSO in medium) for at least 40 minutes at room temperature maintains viable, metabolically active chondrocytes following thawing that is comparable to that of cartilage tissue cryopreserved with cryopreservation solution (e.g., 20% DMSO in medium) using resonant acoustic energy for 30 to 45 minutes at 30 G as shown in FIG. 10 and discussed in Example 6. In some instances, samples processed using resonant acoustic energy may have a lower standard deviation value as compared samples processed by extended incubation.

In some instances, as described in Example 3 and shown in Table 3, the total averaged count of viable cells as assessed by Trypan Blue™ may be 80-90% for at least 3 months, at least 12 months, and up to 24 months at −80° C. In some instances, the retained percent viability of cells, particularly chondrocytes, in the cryopreserved cartilage and osteochondral tissue can be 80%, 81%, 82%, 83%, 84%, 85%, 86%, 87%, 88%, 89%, 90%, 91%, 92%, 93%, 94%, 95%, 96%, 97%, 98%, or 99% for at least 3 months, at least 12 months, and up to 24 months at −80° C.

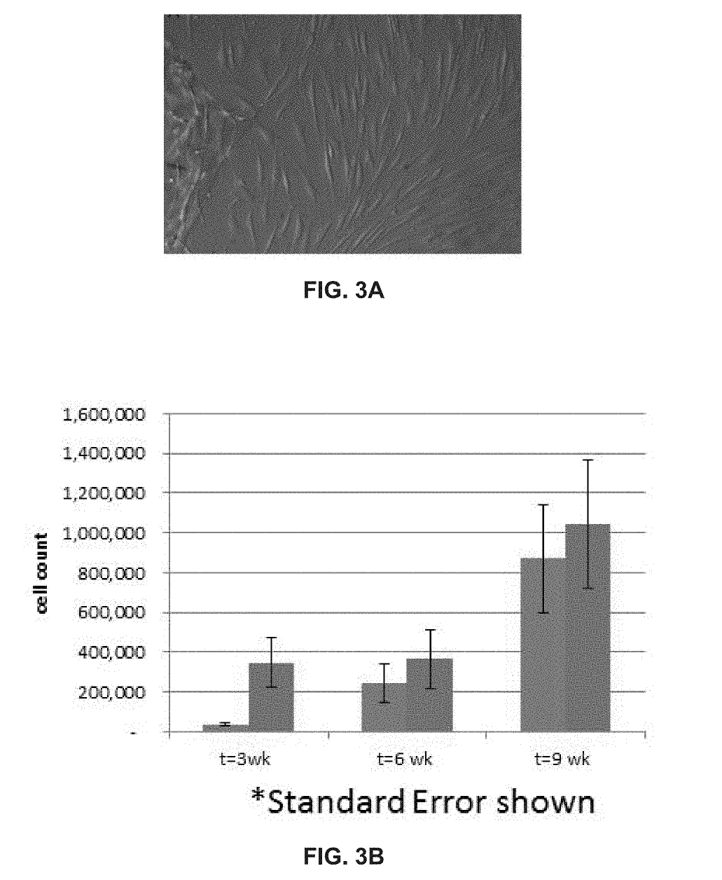

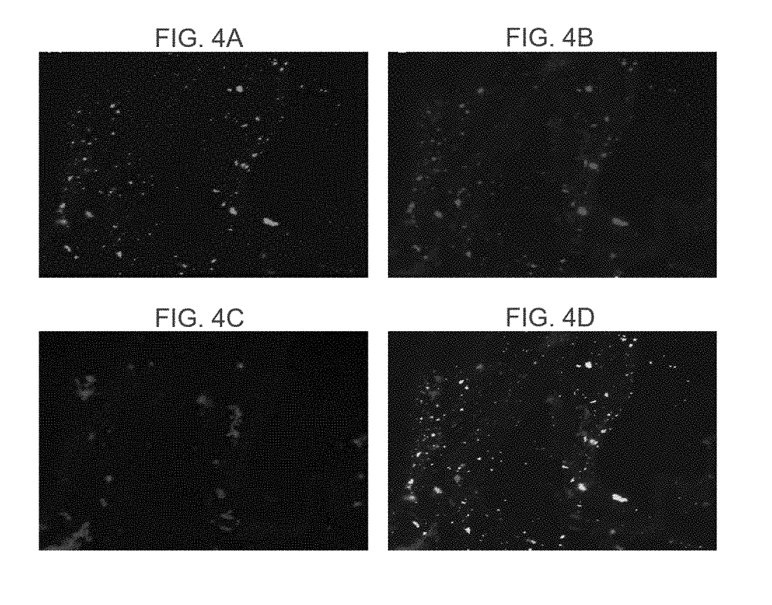

In some instances, cryopreserved tissue grafts produced by the described methods demonstrate functionality in in vitro explant studies over a course of 12 weeks as described in Example 4. For example, the cryopreserved tissue grafts produced may have metabolically active cells that display capabilities for cellular outgrowth as shown in FIG. 3A and FIG. 3B. In some instances, as described in Example 5, the cryopreserved tissue grafts may demonstrate upon thawing and explant culturing in vitro expression of gap junctions (Connexin-42) and Collagen II upon outgrowth of chondrocytes following 12 weeks of explantation as shown in FIGS. 4A-4D. Such expression patterns may reflect directionality and motility of chondrocytes growing out from in vitro explanted cryopreserved tissue grafts.

Provided in this disclosure are also systems for performing the methods of processing tissue for cryopreservation using resonant acoustic energy described herein.

In one aspect, provided are systems useful for manufacturing tissue grafts of the disclosure. The systems include various components. As used herein, the term “component” is broadly defined and includes any suitable apparatus or collections of apparatuses suitable for carrying out the manufacturing methods described herein. The components need not be integrally connected or situated with respect to each other in any particular way. Embodiments include any suitable arrangements of the components with respect to each other. For example, the components need not be in the same room. However, in some instances, the components are connected to each other in an integral unit. In some instances, the same components may perform multiple functions.

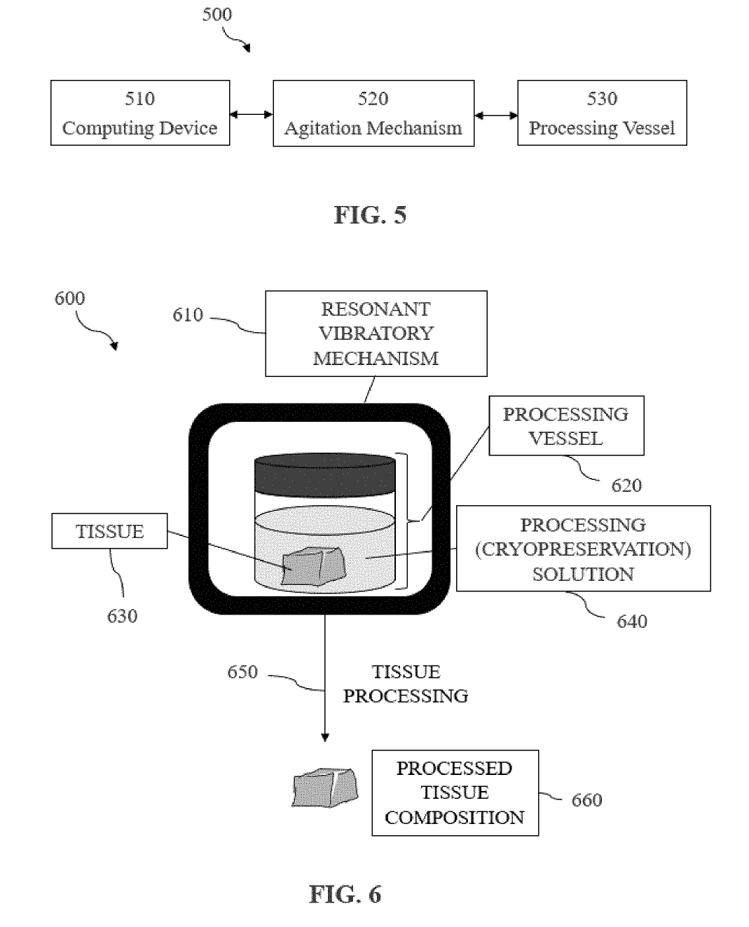

Turning to the drawings, FIG. 5 depicts a schematic of representative system 500 for manufacturing the processed tissue described herein. In some embodiments one or more components shown in FIG. 5 may be omitted. Similarly, in some embodiments, components not shown in FIG. 5 may also be included.

The system 500 may include a processing vessel 530 that is configured to receive the tissue. The processing vessel 530 is of sufficient size to contain a desired volume of tissue and a desired volume of processing solution. Generally, the processing vessel 530 may be made of a non-reactive plastic or resin, metal, or glass. In some instances, the processing vessel 530 may be a beaker, flask, test tube, conical tube, bottle, vial, dish, or other vessel suitable for containing the tissue and the processing solution in a sealed environment.

In another aspect, the system 500 includes an agitation mechanism 520. In some instances, the agitation mechanism 520 is a resonant acoustic vibration device that applies resonance acoustic energy to the processing vessel and its contents. Low frequency, high-intensity acoustic energy may be used to create a uniform shear field throughout the entire processing vessel, which results in rapid fluidization (like a fluidized bed) and dispersion of material. The resonant acoustic vibration device introduces acoustic energy into the processing solution contained by the processing vessel 530 and the tissue components therein. In some instances, the resonant acoustic vibration device includes an oscillating mechanical driver that create motion in a mechanical system comprised of engineered plates, eccentric weights and springs. The energy generated by the device is then acoustically transferred to the material to be mixed. The underlying technology principle of the resonant acoustic vibration device is that it operates at resonance. An exemplary resonant acoustic vibration device is a Resodyn LabRAM ResonantAcoustic® Mixer (Resodyn Acoustic Mixers, Inc., Butte, Mont.). In some instances, the resonant acoustic vibration device may be devices such as those described in U.S. Pat. No. 7,866,878 and U.S. Patent Application No. 2015/0146496, which are each incorporated herein in their entireties.

The system 500 may comprise one or more computing devices such as, for example, computing device 510. Typical examples of computing device 510 include a general-purpose computer, a programmed microprocessor, a microcontroller, a peripheral integrated circuit element, and other devices or arrangements of devices that are capable of implementing the steps that constitute the provided manufacturing processes. The computing device 510 may comprise a memory and a processor. In some instances, the memory may comprise software instructions configured to cause the processor to execute one or more functions. The computing devices can also include network components. The network components allow the computing devices to connect to one or more networks and/or other databases through an I/O interface.

For computing device 510, the software instructions may be configured to cause the processor to coordinate the components of the agitation mechanism 520 to agitate the processing vessel 530 and its contents. For example, the software instruction may cause timed and/or sequential physical, mechanical, or electrochemical adjustment to the components of the agitation mechanism 520 to agitate the processing vessel 530 for one or more periods of time, at one or more agitation speeds, or a combination thereof. In one example, where the agitation mechanism 520 is a resonant acoustic vibration device, the software instructions may include a timed and/or sequential application of resonant acoustic energy of a selected intensity and a selected frequency for a selected period of time. The software instructions may have a range of parameter settings for selection depending on the nature of the tissue, the processing solution, or a combination thereof. In some instances, computing device 510 may be configured as part of the agitation mechanism 520. In another instance, computing device 510 may be separate from but in communication with the agitation mechanism 520.

In some instances, systems of the disclosure include all of the components of system 500. For example, system 500 in its entirety is useful for processing tissue. In other instances, systems of the disclosure may include only some of the components of the system 500. It is contemplated that the systems of the disclosure may also include other components that facilitate the mixing of the tissue with the processing solution to form the processed tissue.

FIG. 6 shows exemplary system 600 for processing tissue for cryopreservation according to aspects of the present disclosure. The resonant vibratory mechanism 610 may house the processing vessel 620 containing a combination comprising tissue 630 and processing solution 640 (i.e. a cryopreservation solution). The tissue processing 650 occurs within the processing vessel 620 within the resonant vibratory mechanism 610. Application of the resonant acoustic energy to process the tissue 650 produces a processed tissue 660. In some cases, the tissue 630 can be intact in cubes, strips, blocks, or some other shape. In some cases, the tissue 630 can be ground tissue or minced tissue. In some cases, the tissue 630 may be a tissue paste or putty. In some instances, the processed tissue or processed tissue product 660 retains a similar shape and similar dimensions to the tissue 630. FIG. 6 is only representative of certain features of the claimed methods and does not show each embodiment or aspect of the claimed methods fully or at all.

Processing vessel 620 is a container or vessel on to which a seal may be applied to maintain the processing solution and tissue inside of the processing vessel and sustain acoustic resonance energy of up to 100 G while maintaining the integrity of the vessel and the seal. Examples include vessels made of non-reactive plastic or resin, metal, or glass. In some embodiments, the processing vessel is disposable. In some embodiments, the processing vessel may be jacketed to facilitate cooling or retention of heat of the processing vessel and the combination therein. In some embodiments, the processing vessel may be vacuum sealed. In the context of this disclosure, loading means placing a tissue and a processing solution into a processing vessel. That processing vessel may be sealed (e.g., aseptically, or air tight) so as to contain contents therein when resonant acoustic energy is applied. An exemplary processing vessel may be a lidded vessel capable of holding a volume of up to 3,000 mL. In some instances, the processing vessel 620 may hold a volume of up to 500 ml, 1 L, 2 L, or 3 L.

In some instances, the processing vessel 620 and the combination of the cryopreservation solution 640 and tissue 620 therein may be maintained at a temperature between 0° C. and 50° C. In some instances, the resonant vibratory mechanism 610 may comprise a cooling system to facilitate maintaining the temperature of its interior into which the processing vessel 620 is placed.

As discussed above, either before or following processing, the tissue may optionally be soaked in a cryopreservation solution. Subsequently, the processed tissue is placed in freezing temperatures to freeze the processed tissue, producing a cryopreserved tissue.

In another aspect, method of cryopreserving tissue may not use resonant acoustic energy. In one aspect, the tissue is placed in a cryopreservation solution and soaked for up 2 hours prior to being placed at freezing temperatures. To soak the tissue, it is submerged in a suitable container containing a cryopreservation solution as described above. In some instances, the container is sealed or its opening covered so that the tissue is enclosed therein in the cryopreservation solution. For example, the tissue may be soaked for 5 min, 10 min, 15 min, 20 min, 25 min, 30 min, 40 min, 50 min, 60 min, 75 min, 90 min, 120 min, or an amount of time otherwise less than 2 hours. In some instances, the tissue may be soaked at room temperature or at a refrigerated temperature (e.g., 4° C.). In some instances, the tissue is agitated on an orbital shaker, a rocker, or a stir plate (with magnetic stirrer in vessel containing tissue and cryopreservation solution) while be soaked. In some instances, the cryopreservation solution is sonicated while the tissue is being soaked therein (continuously, for a portion of the soaking period, or intermittently during the soaking period).

Exemplary embodiments of this disclosure include the following.

### Embodiment 1

A method of cryopreserving tissue, the method comprising:

(a) loading a processing vessel with a tissue and a cryopreservation solution, thereby providing a combination comprising the tissue and the cryopreservation solution disposed in the processing vessel;

(b) applying resonant acoustic energy to the processing vessel, thereby vibrating the processing vessel and the combination disposed therein to form a processed tissue comprising the tissue mixed with the cryoprotectant; and

(c) freezing the processed tissue to form a cryopreserved tissue.

### Embodiment 2

The method of embodiment 1, wherein the tissue is wherein the tissue is cartilage tissue or osteochondral tissue.

### Embodiment 3

The method of embodiment 1, wherein the cryopreservation solution comprises a buffer or culture medium containing a cryoprotectant agent.

### Embodiment 4

The method of embodiment 3, wherein the cryoprotectant agent is at least one of dimethyl sulfoxide (DMSO), methanol, butanediol, propanediol, polyvinylpyrrolidone, glycerol, hydroxyethyl starch, alginate, or a glycol.

### Embodiment 5

The method of embodiment 3, wherein the cryoprotectant agent is DMSO.

### Embodiment 6

The method of embodiment 1, wherein the cryopreservation solution comprises 10% to 40% (vol/vol) of the cryoprotectant agent.

### Embodiment 7

The method of embodiment 1, wherein the cryopreservation solution comprises 10% to 20% (vol/vol) of the cryoprotectant agent.

### Embodiment 8

The method of embodiment 1, wherein the processed tissue is removed from the processing vessel and soaked in a second cryopreservation solution for up to 2 hours prior to freezing, or wherein the tissue is soaked in a second cryopreservation solution for up to 2 hours prior to being placed in the processing vessel.

### Embodiment 9

The method of embodiment 1, wherein resonant acoustic energy is applied for 10 to 60 minutes.

### Embodiment 10

The method of embodiment 1, wherein resonant acoustic energy is applied for 30 to 45 minutes.

### Embodiment 11

The method of embodiment 1, wherein resonant acoustic energy is applied for 40 minutes.

### Embodiment 12

The method of embodiment 1, wherein the resonant acoustic energy exerts 10 to 60 times the energy of G-force (10-60 G) on the processing vessel and combination therein.

### Embodiment 13

The method of embodiment 1, wherein the resonant acoustic energy exerts 30 times the energy of G-force (30 G) on the processing vessel and combination therein.

### Embodiment 14

The method of embodiment 1, wherein the resonant acoustic energy has a frequency of 15 Hertz to 60 Hertz.

### Embodiment 15

The method of embodiment 1, wherein the resonant acoustic energy has a frequency of 60 Hertz.

### Embodiment 16

The method of embodiment 1, wherein the tissue, the processing solution, or both, are evaluated after application of the resonant acoustic energy to assess at least one characteristic.

### Embodiment 17

The method of embodiment 1, wherein the tissue is frozen to a temperature of −80° C.

### Embodiment 18

The method of embodiment 1, wherein the tissue is frozen in a solution comprising serum and 10-20% cryoprotectant agent.

### Embodiment 19

The method of embodiment 18, wherein the cryoprotectant agent is DMSO.

### Embodiment 20

A cryopreserved tissue product made according to the method of any of embodiments 1-19.

### Embodiment 21

The cryopreserved tissue product of embodiment 20, wherein the cryopreserved tissue product retains at least 70% cell viability after two years in storage upon being thawed.

### Embodiment 22

The cryopreserved tissue product of embodiment 20, wherein the cryopreserved tissue product retains at least 80% cell viability after two years in storage at −80° C. upon being thawed.

### Embodiment 23

The cryopreserved tissue product of embodiment 20, wherein the cryopreserved tissue product retains at least 90% cell viability after two years in storage at −80° C. upon being thawed.

### Embodiment 24

The cryopreserved tissue product of any one of embodiments 21-23, wherein the cryopreserved tissue is cryopreserved cartilage tissue.

### Embodiment 25

The cryopreserved tissue product of any one of embodiments 21-24, wherein the percent viability has a range of less than 5% variability.

### Embodiment 26

The cryopreserved tissue product of any one of embodiments 21-23, wherein the cryopreserved tissue is cryopreserved osteochondral tissue.

### Embodiment 27

The cryopreserved tissue product of any one of embodiments 21-23 or 26, wherein the percent viability has a range of 5-6% variability.

### Embodiment 28

A method of cryopreserving a tissue, the method comprising soaking the tissue in a cryopreservation solution for up to 2 hours and then placing the tissue at freezing temperatures, thereby producing a cryopreserved tissue.

### Embodiment 29

The method of embodiment 28, wherein the tissue is cartilage tissue or osteochondral tissue.

### Embodiment 30

The method of embodiment 28, wherein the cryopreservation solution comprises a buffer or culture medium containing a cryoprotectant agent.

### Embodiment 30

The method of embodiment 30, wherein the cryoprotectant agent is at least one of dimethyl sulfoxide (DMSO), methanol, butanediol, propanediol, polyvinylpyrrolidone, glycerol, hydroxyethyl starch, alginate, or a glycol.

### Embodiment 31

The method of embodiment 30, wherein the cryoprotectant agent is DMSO.

### Embodiment 32

The method of embodiment 28, wherein the cryopreservation solution comprises 5-40% (vol/vol) of the cryoprotectant agent.

### Embodiment 33

The method of embodiment 28, wherein the cryopreservation solution comprises 10-20% (vol/vol) of the cryoprotectant agent.

### Embodiment 34

The method of embodiment 28, wherein the tissue is soaked for 5 min, 10 min, 15 min, 20 min, 25 min, 30 min, 40 min, 50 min, 60 min, 75 min, 90 min, or 120 min.

### Embodiment 35

The method of embodiment 28, wherein the tissue is soaked for 30 min to 60 min.

### Embodiment 36

The method of embodiment 28, wherein the tissue is soaked at room temperature or at a temperature of 2° C.-8° C.

### Embodiment 37

The method of embodiment 28, wherein the tissue is agitated on an orbital shaker, a rocker, or a stir plate while being soaked.

### Embodiment 38

The method of embodiment 28, wherein the cryopreservation solution is sonicated while the tissue is being soaked therein.

### Embodiment 39

The method of embodiment 28, wherein the tissue is frozen to a temperature of −80° C.

### Embodiment 40

The method of embodiment 28, wherein the tissue is frozen in a solution comprising serum and 10-20% cryoprotectant agent.

### Embodiment 41

The method of embodiment 40, wherein the cryoprotectant agent is DMSO.

### Embodiment 42

A cryopreserved tissue product made according to the method of any of embodiments 28-41.

### Embodiment 43

The cryopreserved tissue product of embodiment 42, wherein the tissue product retains at least 70% cell viability after 1 week in storage at −80° C. upon being thawed.

### EXAMPLES

### Example 1. Analysis of Cryopreservation Conditions

A. Cartilage Tissue Grafts

Fresh cartilage tissue was recovered from cadaveric human donors, between 16 and 35 years of age, consented for research and prepared at various diameters, ranging from 7 to 20 mm, all with 1 mm thickness and laser etched with a 1.5 mm square pattern as described in U.S. Pat. No. 9,186,253, which is incorporated by reference in its entirety for all purposes (such grafts are marketed commercially as ProChondrix® by AlloSource®, Centennial, Colo.). Fresh tissue was used for all studies except flow cytometry, where samples were tested up to one week after the 35 day shelf life expiration. All samples were recovered in Chondrocyte Growth Medium (Cell Applications, San Diego, Calif.). Non-viable ProChondrix controls were prepared by storing expired grafts in 70 percent isopropyl alcohol (IPA) for at least 12 hours.

Alkaline Phosphatase stain (AP, Vector Laboratories, Burlingame, Calif.) was applied to the entire cartilage graft, while Von Kossa stain (“VK”, IHC World, Ellicott City, Md.) was applied to 5 μm thick sections and placed under UV light for 1.5 hours. Flow cytometry was used to quantify osteoblast progenitor cells (anti-osteocalcin, BD BioSciences, San Jose, Calif.). Antibodies were allowed to react for one hour prior to two washes and quantification. The grafts were embedded in a tissue freezing compound, sectioned and stained with antibodies to Osteopontin (GeneTex, Irvine, Calif.), a marker for osteoblasts, and Collagen II (Proteintech, Chicago, Ill.), a marker for cartilage. Slides were fixed in cold 50% acetone, 50% methanol solution for five minutes, washed with Phosphate Buffered Saline (PBS) and stained with primary antibodies at a concentration of 1:200, and incubated overnight at 40° C. The slides were washed with PBS, incubated with secondary antibodies, fluorescein isothiocyanate (FITC, Invitrogen, Waltham, Mass.) and tetramethylrhodamine isothiocyanate (TRITC, Abcam, Cambridge, UK), at a concentration of 1:100 for two hours. Slides were washed and mounted using 4′,6-diamidino-2-phenylindole (DAPI) coated cover slips. Slides were imaged using confocal and epifluorescence microscopy.

AP Staining.

Alkaline phosphatase (AP) is an enzyme involved in osteogenesis and plays an early role in the process of calcification. The grafts showed dense AP staining as shown in FIG. 7, indicating that the grafts may have osteogenic activity.

Calcium Deposition.

Calcium deposition is a characteristic of bone matrix formation and a signifier of osteoblast differentiation. VK staining measures the extent of mineral deposition within the matrix, an indirect measurement of calcium content. FIG. 8 depicts the VK stain for ProChondrix allografts, indicating mineral deposition as shown by dark brown/black staining at the edge of the graft.

Flow Cytometry.

The presence of specific markers for osteoblast progenitor cells was qualitatively and quantitatively measured using confocal microscopy and flow cytometry, respectively. Osteocalcin is a protein specifically secreted by osteoblasts, and serves as a marker for osteogenic activity. All graft samples were tested up to one week after the 35-day shelf life, representing a graft with less cellular activity as compared to standard production grafts sold by AlloSource. Osteocalcin expression was detected in all except for one ProChondrix graft as shown in in the table below. Donor-to-donor variation contributed to both the variation seen in Osteocalcin expression, as well as the level of digestion between grafts. This variation in the level of digestion may account for both the high standard deviation, as well as contributing to the lack of Osteocalcin expression on one of the grafts.

| | Viable | Non-Viable |
|---|---|---|
| Number of samples | 8 | 3 |
| Average osteocalcin cell count | 28,147 | 161 |
| Standard deviation | 35,416 | 845 |
| Average osteocalcin per mm³ | 22.4 | 0.13 |

Microscopy.

To compare the osteogenic and chondrogenic activity, the grafts were stained with Osteopontin to test for the presence of osteoblast progenitor cells, and Collagen II for the presence of chondrocytes. Similarly to Osteocalcin (OCN) expression, Osteopontin expression indicates the presence of osteoblasts and osteoblast differentiation. Immunohistochemical staining of the grafts showed expression of both Collagen II (diffuse staining plus discrete dots) and Osteopontin (discrete dots) in the grafts as shown in FIG. 9, reflecting both osteogenic and chondrogenic activity.

In view of the above analysis, the cartilage grafts could be considered osteochondral grafts due to the presence of osteoblast cells at the edge of the grafts where the cartilage tissue was in contact with the bone. However, surgeons familiar with tissue grafts would generally consider this type of graft to be a cartilage graft due to its appearance (i.e. as a thin sheet of cartilage visually lacking bone tissue attached). As such, such grafts are referred to as cartilage tissue grafts in this disclosure and in the following examples and would be expected to have similar properties in the context of the instant disclosure as if there were no bone cells present.

B. Cryopreservation Conditions

Cartilage tissue grafts were recovered from cadaveric human donors, between 16 and 39 years of age, consented for research and prepared at a diameter of 11 mm, 1 mm thickness and laser etched with a 1.5 mm square grid pattern. Tissue was processed and frozen within one week of death of death from the donor. Three grafts per condition were placed into a specimen cup containing 80 mL Minimal Essential Medium (MEM) and 20 ml of DMSO (20%). The specimen cup with grafts was then placed in a Resodyn LabRAM ResonantAcoustic® Mixer (Resodyn Acoustic Mixers, Inc., Butte, Mont.) and processed at 30 G for 30 min, 35 min, 40 min, or 45 min. Grafts were removed from the specimen cups and placed in a 15 ml cryogenic jar (Thermo Scientific™ Nalgene™ general long-term Storage cryogenic tube; Thermo Fisher) with 10 ml of cryoprotectant solution (90% FBS and 10% DMSO). The tube was secured in a Nalgene® Mr. Frosty™ freezing container (ThermoFisher Scientific) and placed in a −80° C. freezer for a minimum of 3 hours. The jar was then removed from the Mr. Frosty™ container and returned to −80° C. freezer for one week.

The grafts were thawed in a 37° C. water bath, removed from the cryopreservation medium and placed in a 12 well plate with Chondrocyte Growth Medium and placed into a 37° C. incubator for 1 week before further testing.

Samples were assessed using a Presto Blue assay before and after cryopreservation. The assay utilizes a live cell's reducing environment to fluorescently label metabolically active cells. A 1:10 ratio of PrestoBlue® reagent (Life Technologies, Carlsbad, Calif.) to cell culture medium was added to a sample so that the sample is covered by the medium. The metabolic activity of the cells changes the color of the medium. After 3 hours incubation, 100 μl aliquots were taken from each sample and added to a multi-well plate for reading in a plate reader. The samples were then rinsed in media. The data is shown below in Table 2. Processing the tissue at 30 G for 40 min was found to yield the highest percent viability post-thaw.

TABLE 2
Presto Blue ™ metabolic assay assessment of cryopreserved grafts

| | | |
|---|---|---|
| Before(#cells) | After(#cells) | % viable post thaw |

30 G/30 Min

| | | |
|---|---|---|
| 3271 | 976 | 29.84% |
| 1029 | 764 | 74.25% |
| 1831 | 882 | 48.17% |
| x = 2043.666667 | x = 874 | x = 50.75% |

30 G/35 Min

| | | |
|---|---|---|
| 1998 | 1451 | 72.62% |
| 3132 | 1209 | 38.60% |
| 1263 | 802 | 63.50% |
| x = 2131 | x = 1154 | x = 58.24% |

30 G/40 Min

| | | |
|---|---|---|
| 1031 | 647 | 62.75% |
| 887 | 865 | 97.52% |
| 1023 | 897 | 87.68% |
| x = 980.3333333 | x = 803 | x = 82.65% |

30 G/45 Min

| | | |
|---|---|---|
| 1617 | 1018 | 62.96% |
| 1483 | 695 | 46.86% |
| 2825 | 820 | 29.03% |
| x = 1975 | x = 844.3333333 | x = 46.28% |

In another experiment, tissue grafts were prepared as described above from three human donors. At least three grafts from each donor were processed in the Resodyn LabRAM mixer in DMEM/20% DMSO at 30 G for 40 min. Another set of at least three grafts from each donor were were soaked in DMEM/20% DMSO for 40 min at room temperature (approx. 20-28° C.). Both sets of grafts were then frozen as described above for a minimum of 3 hours in a Mr. Frosty container at −80° C. before being removed and placed back at −80° C. The samples were maintained at −80° C. for one week.

The grafts were thawed in a 37° C. water bath, removed from the cryopreservation medium and placed in a 12 well plate with Chondrocyte Growth Medium and placed into a 37° C. incubator for 1 week before further testing.

Samples were assessed using Presto Blue assay before and after cryopreservation. The assay was performed as described above. As shown in FIG. 2, there was no statistical significance (p=0.27) in the metabolic activity of the test grafts and control tissue grafts. The average cell count for the control samples following cryopreservation was found to be slightly higher than for the test samples, however, a larger standard deviation was observed (control: 590,836±456,835 vs test: 415,394±332,798). All data depicts the average of three donors for each group, with at least three samples per donor, as shown in the graph below.

### Example 2. Preparation of Cryopreserved Cartilage and Osteochondral Grafts

Preparation of Cartilage Grafts.

Cartilage tissue grafts (6-18) were recovered from eight cadaveric human donors, between 16 and 35 years of age, consented for research (shaved from knee and ankle joints). The tissue was punched into discs having a diameter of 11 mm and shaved to 1 mm thickness. The discs were then laser etched with a 1.5 mm square grid pattern. Some grafts for use as fresh tissue controls were stored at 4° C. (such grafts are marketed commercially as ProChondrix, AlloSource, Centennial, Colo.). Other grafts for use in test conditions were processed for cryopreservation as set forth below. All the grafts were processed within one week of date of death of donor (control grafts at 4° C.; test grafts frozen).

Cryopreservation of Cartilage Grafts.

Grafts were placed into a specimen cup containing 80 mL Minimal Essential Medium (MEM) and 20 mL of DMSO (20%). The specimen cup with grafts was then placed in a Resodyn LabRAM ResonantAcoustic® Mixer (Resodyn Acoustic Mixers, Inc., Butte, Mont.) and agitated for 40 minutes at 30 G. Grafts were removed from the specimen cups and placed in a 15 ml cryogenic tube (Thermo Scientific™ Nalgene™ general long-term Storage cryogenic tube; Thermo Fisher) with 10 ml of cryoprotectant solution (90% FBS and 10% DMSO). The tube was secured in a Nalgene® Mr. Frosty™ freezing container (ThermoFisher Scientific) and placed in a −80° C. freezer for a minimum of 3 hours. The tube was then removed from the Mr. Frosty™ container and returned to −80° C. freezer for long term storage.

Recovery of Cryopreserved Cartilage Grafts.

Cryopreserved grafts were thawed in a 37° C. water bath, removed from the cryopreservation medium and placed in a 12 well plate with Chondrocyte Growth Medium and placed into a 37° C. incubator overnight before further testing.

Preparation of Osteochondral Grafts.

Osteochondral tissue grafts (8) were recovered from eight cadaveric human donors, between 16 and 39 years of age, consented for research and prepared into dowels of 7 to 20 mm in diameter, 1-3 mm thick cartilage. Whole talus osteochondral tissue grafts (4) were recovered from four cadaveric human donors, between 16 and 39 years of age, consented for research. The cartilage on the dome of the talus was left intact, and the sides and the bottom of the grafts were cut exposing the cancellous bone. Fresh tissue control grafts were stored at 4° C. (such grafts are marketed commercially as ProChondrix®, AlloSource, Centennial, Colo.). Test grafts were processed for cryopreservation as set forth below. Grafts were processed and frozen within one week of date of death of donor.

Cryopreservation of Osteochondral Grafts.

Osteochondral grafts were placed into a specimen cup or Nalgene jars (depending on tissue size) containing 20% DMSO in Minimal Essential Medium (MEM). The specimen cups or jars were then each individually placed in a Resodyn LabRAM ResonantAcoustic® Mixer (Resodyn Acoustic Mixers, Inc., Butte, Mont.) and agitated for 40 minutes at 30 G. Dowel grafts were then placed in a 15 ml cryogenic jars (Thermo Scientific™ Nalgene™ general long-term storage cryogenic tube; ThermoFisher) with 10 ml of cryoprotectant solution (80% FBS and 20% DMSO). Talus grafts were placed in a 60 ml cryogenic jars (Thermo Scientific™ Nalgene™ general long-term storage cryogenic jar; ThermoFisher) and the jar filled with cryoprotectant solution (80% FBS and 20% DMSO) to cover the tissue (approx. 40 mL). For freezing, the jars were secured in a Nalgene® Mr. Frosty™ freezing container (ThermoFisher Scientific) and placed in a −80° C. freezer for a minimum of 3 hours until frozen. The jars were then removed from the Mr. Frosty™ container and returned to −80° C. freezer for long term storage.

Recovery of Cryopreserved Osteochondral Grafts.

Cryopreserved osteochondral grafts were thawed in a 37° C. water bath, and the cartilage tissue was shaved from the bone. The cartilage tissue was placed in a 12 well plate (tissue from dowel grafts) or a 6 well plate (tissue from talus grafts) with Chondrocyte Growth Medium and placed into a 37° C. incubator overnight before further testing.

### Example 3. Viability Assessment of Cryopreserved Cartilage and Osteochondral Grafts by Trypan Blue Exclusion Test

The viability of the chondrocytes in the cryopreserved grafts prepared as described in Example 2 was assessed by Trypan Blue exclusion assay. The amount of live cells as compared to the total number of cells of the cells liberated from the digested grafts was determined.

Cartilage grafts were assessed directly after thawing for chondrocyte viability. For osteochondral grafts, the cartilage was shaved from the bone of the thawed grafts, and the cartilage was then assessed for chondrocyte viability. Thawed cryopreserved grafts were digested by incubating samples at 37° C. overnight in a collagenase solution (Collagenase Type I (MediaTech, Manassas, Va.)+Collagenase Type II (Life Technologies, Waltham, Mass.) in CGM). Following digestion, grafts were filtered through a 100 μm strainer, and then spun at 500 G for 5 minutes. Cell pellets were resuspended in 2 mL fluorescently activated cell sorting (FACS) buffer. This cell solution was then utilized for viability studies Trypan Blue™ as described below.

Trypan Blue™ stain is a frequently used assay to determine cell viability in which live cells are left unstained (exclude the dye) while dead cells are stained with a blue dye. The unstained and stained cells can then be counted under a microscope or an automated cell counter. An automated cell counter outputs a viability percentage for each sample. For the Trypan Blue exclusion assay, an aliquot of the cell solution was diluted 1:1 with Trypan Blue stain (Invitrogen, Carlsbad, Calif.). This solution was then read using Countess® Automatic Cell Counter (Invitrogen, Carlsbad, Calif.) using the Countess® disposable hemocytometers.

Chondrocyte viability in the cryopreserved cartilage grafts was assessed at 6 months, 12 months, and 24 months in long-term storage (−80° C.). Viability of the cryopreserved samples was compared to unfrozen cartilage tissue prepared in the same way but stored at 4° C. for 35 days, which is the current shelf life for the AlloSource ProChondrix™ product at which a minimum of 70% cell viability is retained. The viability percentage for each sample was read twice for each of the graft samples. The results of this analysis are below in Table 3. For comparison, viability data for commercial Cartiform™ cartilage product (Osiris Therapeutics, Inc., Columbia, Md.) is included as published in Geraghty, S. et al., J. Orthopaedic Surgery &Res. 20:66 (13 pages) (2015).

The described cryopreservation method results in substantial viability in the cryopreserved cartilage grafts for up to 2 years in storage that is comparable to the viability of unfrozen cartilage tissue. Average viability of samples was 88.30% at 6 months, 89.37% at 1 year, and 94.97% at 2 years; each well above the desired 70% viability. The method also provides consistent viability across samples as reflected by a tight standard deviation in the observed viability (ranging from 3.29% for the 1 year samples to 6.42% for the 6 month samples). Impressively, the standard deviation at 2 years was only 3.38%. In no instance was the measured viability of any of the cryopreserved cartilage samples prepared as described herein below 83%.

TABLE 3
Trypan Blue ™ viability assessment of unfrozen and cryopreserved cartilage grafts

| | Unfrozen cartilage | Cryopreserved | Cryopreserved | Cryopreserved | Cartiform ™ (Osiris |
|---|---|---|---|---|---|
| | tissue (35 day at | cartilage tissue | cartilage tissue | cartilage tissue | cryopreserved |
| | 4° C.) | (6 mo. at −80° C.) | (1 yr at −80° C.) | (2 yr at −80° C.) | cartilage product) |
| | n | | | | |
| | 10 | 6 | 12 | 12 | N/A |
| Average | 87.50% | 88.30% | 89.37% | 94.97% | 70.50% |
| Viability | | | | | |
| Range | 73.5-99% | 77.5-95% | 83.00-93.70% | 86.67-98.67% | 54.5-88.5 |
| Standard | 8.66% | 6.42% | 3.29% | 3.38% | N/A |
| Deviation | | | | | |

Chondrocyte viability in the cryopreserved osteochondral grafts was assessed at 1-2 months in long-term storage (−80° C.). Viability of the cryopreserved samples was compared to unfrozen osteochondral tissue prepared in the same way but stored at 4° C. for 35 days. The viability percentage for each sample was read twice for each of the graft samples. The described cryopreservation method results in substantial viability in both sets of cryopreserved osteochondral grafts at 1-2 months in storage. Average viability of the dowel sized samples was 88.74% with a standard deviation of 4.72% (n=8; range: 81.8-95.2%). Average viability of the whole talus samples was 92.13% with a standard deviation of 5.89% (n=4; range: 84-98%). For both sized samples; each sample retained chondrocyte viability above the desired 70% viability. The method also provides consistent viability across samples as reflected by tight standard deviations. In no instance was the measured viability of any of the cryopreserved osteochondral samples prepared as described herein below 81.8%.

### Example 4. Metabolic Activity of Cryopreserved Cartilage Grafts Following Explantation

Thawed cartilage grafts prepared as described in Example 2 were affixed to the bottom of a well plate to mimic the intended clinical application of implantation and permit assessment of functionality. Fibrin glue (Baxter, Deerfield, Ill.) was used to adhere a graft to the bottom of each well of a 6 well plate (6 grafts total). Explanted grafts were cultured under standard conditions (37° C., 5% CO₂) for 9 weeks. Time points were taken at 3 weeks, 6 weeks, and 9 weeks. To observe the metabolic activity of the explanted grafts, a 10% PrestoBlue® reagent (Life Technologies, Waltham, Mass.) in chondrocyte growth medium was added to each sample and incubated for 3 hours at 37° C. A 100 μL aliquot of each sample was then read on a plate reader against a standard curve consisting of cultured chondrocytes at a wavelength of 535, 615 nm.

A separate sample set of cartilage allograft tissue (2 mm×1 mm) were explanted for immunofluorescence microscopy analysis. Explanted grafts were cultured for 9 weeks as described above. Culture medium was removed and the explants were washed 1× with Phosphate Buffered Saline (PBS). A solution of 50% acetone/50% methanol was prepared, and 3 mL were added to each well. Samples were incubated at 4° C. for 15 minutes and then washed in PBS three times. Nonspecific binding sites were blocked by adding 3 mL of 10% Fetal Bovine Serum (FBS) in Phosphate Buffered Saline (PBS) to each well and incubated for 1 hour. The following primary antibodies were used at a concentration of 1:200 in 1.5% FBS/PBS solution: Collagen II (Proteintech, Chicago, Ill.) and Connexin-43 (Abcam, Cambridge, UK). Ki-67 Alexa Fluor 647 (BioLegend, San Diego, Calif.) at a concentration of 1:100 was added in the same solution. The explants were incubated overnight at 4° C. in the dark and then washed three times with PBS. A solution was made of each of the secondary antibodies, fluorescein isothiocyanate (FITC, Invitrogen, Carlsbad, Calif.) and tetramethylrhodamine isothiocyanate (TRITC, Abcam, Cambridge, UK), at a concentration of 1:100 in 1.5% FBS/PBS solution, which was then added to each of the explants and incubated for 2 hours at room temperature in the dark. Following this, the explants were washed with PBS three times. As a final step, the explants were incubated with the stain 4′,6-diamidino-2-phenylindole (DAPI) for 5 minutes at 4° C. in the dark, and then washed with PBS three times. Explants were then imaged using confocal microscopy.

The outgrowth of cells was evident surrounding each of the explanted grafts post-cryopreservation and could be easily seen through light microscopy. A representative field showing chondrocytes outgrown onto the well bottom is shown in FIG. 3A. The image depicted was taken after 3 weeks of recovery and 3 weeks of explantation. The explantation of 6 months cryopreservation resulted in all donors displaying cell outgrowth resembling approximately 70-80% confluence in a six well dish, as seen in FIG. 3A. This was also displayed while quantifying the metabolic activity of each explanted graft using Presto Blue. Presto Blue uses the cell's reducing environment to produce a fluorescent dye and thus quantitatively measures viability. (See Invitrogen™ Presto Blue® Viability Reagent Frequently Asked Questions; version Mar. 21, 2012; available from: tools.thermofisher.com/content/sfs/manuals/PrestoBlueFAQ.pdf.) FIG. 3B displays the metabolic activity of these explanted grafts following a course of 9 weeks. For this particular study, we compared fresh and cryopreserved ProChondrix utilizing different donors to compare the disparate processes. An upward growth was seen in both fresh ProChondrix samples and cryopreserved ProChondrix samples over the course of 9 weeks. Statistical significance was found at the 3 week time point between fresh and cryopreserved ProChondrix, but no statistical significance was found at 6 or 9 weeks between groups.

### Example 5. Immunofluorescence Studies of Cryopreserved Cartilage Grafts for Cellular Outgrowth and Mobility—12 Weeks Post-Thaw

Cell outgrowth and mobility were assessed following the explantation of the grafts described in Example 4. Cell outgrowth requires a vast amount of cell-cell interaction and communication in order to display directionality and mobility. This intercellular communication is immensely important in regulating normal cell function, tissue development, and cellular motility. Gap junctions are channels that connect cells, allowing for them to communicate amongst each other and are made up of specific gap junction proteins, also referred to as connexins. Articular cartilage isolated from bovine was found to have functional Connexin-43 (Cx43) gap junctions (Donahue, H., et al., J. of Bone and Mineral Res. 10(9):1359-1364 (2009)), which have been shown to be correlated with cell motility (Xu, X., et al., Development 133: 3629-3639 (2006)).

Immunofluorescent staining qualitatively shows the expression levels of Connexin-43 and Collagen II. The outgrowth of cells were shown to express Connexin-43 gap junctions, as seen in FIG. 4A, as well as Collagen II expression, FIG. 4B. This substantiates prior literature that cartilage is mediated through Connexin-43 gap junctions. It also displays the vast amount of cell-cell interaction which could be involved with cell motility. Collagen II deposits were also displayed within the outgrowth, FIG. 4B, which may suggest chondrogenesis. FIG. 4C shows the presence of nuclei, while FIG. 4D represents a composite of FIGS. 4A-4C.

### Example 6. Comparison of Cryopreservation Methodologies

Cartilage grafts were obtained from three cadaveric human donors, between 16 and 35 years of age, consented for research (shaved from knee and ankle joints). Three grafts from each donor were prepared and cryopreserved as described in Example 2. These grafts, which are processed by resonant acoustic wave energy are designated as “RAW” grafts. An additional three grafts from each donor were prepared as described in Example 2 and then cryopreserved by soaking in the cryopreservation solution at room temperature while the “RAW” grafts were being processed (40 min). These grafts are designated as “no RAW” grafts. All of grafts were packaged and stored in a −80 freezer to store for 1 week. Samples were then thawed in a 37° C. water bath, removed from the cryopreservation medium and placed in a 12 well plate (one disk per well) with Chondrocyte Growth Medium (CGM), and then placed into a 37° C. incubator to allow recovery from cryopreservation. The grafts were recovered in CGM for 5 days. A rough preliminary viability assessment was performed using PrestoBlue® reagent (Life Technologies, Waltham, Mass.) and then the grafts were again incubated in CGM at 37° C. overnight.

The tissue was digested with a collagenase solution (Collagenase Type I (MediaTech, Manassas, Va.)+Collagenase Type II (Life Technologies, Waltham, Mass.) in CGM) to release the chondrocytes therein. The collagenase solution was warmed for 30 minutes at 37° C. prior to the start of the digestion. Each graft sample was placed in a well of a 6 well plate with 4 ml of warmed collagenase solution. The samples were minced into 4 pieces and then were incubated at 37° C., 110 rpm for 4 hours. Following digestion, grafts were filtered through a 100 μm strainer, and then spun at 500 G for 5 minutes. Cell pellets were each resuspended in 2-10 mL FACS buffer to form a cell solution.

The cell solutions from the digested grafts (30 μL) was mixed with Trypan Blue™ stain (Invitrogen, Carlsbad, Calif.) (30 μL) in microcentrifuge tubes. For each sample, 10 μL of this mixture was then read using Countess® Automatic Cell Counter (Invitrogen, Carlsbad, Calif.) using the Countess® disposable hemocytometers. Percent viability is an output reading for the Countess® Automatic Cell Counter, and this percentage was recorded. This data is shown in FIG. 10. Similarly to the flow cytometry assessment, no statistical significance was found between the percent viabilities of “RAW” and “no RAW” samples (p=0.342). The “RAW” group displayed a higher percent viability (78.2±5.6) but a lower standard deviation value as compared the “no RAW” samples.

Overall, this analysis demonstrates that sufficiently high chondrocyte viability may be obtained for cartilage tissue grafts using a 20% DMSO cryopreservation medium whether using resonant acoustic wave energy or extended incubation to permit integration of the cryoprotectant agent into the tissue.

All patents, patent publications, patent applications, journal articles, books, technical references, and the like discussed in the instant disclosure are incorporated herein by reference in their entirety for all purposes.

It is to be understood that the figures and descriptions of the disclosure have been simplified to illustrate elements that are relevant for a clear understanding of the disclosure. It should be appreciated that the figures are presented for illustrative purposes and not as construction drawings. Omitted details and modifications or alternative embodiments are within the purview of persons of ordinary skill in the art.

It can be appreciated that, in certain aspects of the disclosure, a single component may be replaced by multiple components, and multiple components may be replaced by a single component, to provide an element or structure or to perform a given function or functions. Except where such substitution would not be operative to practice certain embodiments of the disclosure, such substitution is considered within the scope of the disclosure-.

The examples presented herein are intended to illustrate potential and specific implementations of the disclosure. It can be appreciated that the examples are intended primarily for purposes of illustration of the disclosure for those skilled in the art. There may be variations to these diagrams or the operations described herein without departing from the spirit of the disclosure. For instance, in certain cases, method steps or operations may be performed or executed in differing order, or operations may be added, deleted or modified.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not restrictive purposes, and alternative embodiments will become apparent to readers of this patent. Accordingly, the present disclosure is not limited to the embodiments described above or depicted in the drawings, and various embodiments and modifications can be made without departing from the scope of the claims below.

What is claimed is:

1. A method of cryopreserving tissue, the method comprising:
(a) loading a processing vessel with a tissue and a cryopreservation solution, thereby providing a combination comprising the tissue and the cryopreservation solution disposed in the processing vessel, wherein the tissue is cartilage tissue or osteochondral tissue;
(b) applying resonant acoustic energy to the processing vessel, thereby vibrating the processing vessel and the combination disposed therein to form a processed tissue comprising the tissue mixed with the cryoprotectant; and
(c) freezing the processed tissue to form a cryopreserved tissue.

2. The method of claim 1, wherein the cryopreservation solution comprises a buffer or culture medium containing a cryoprotectant agent.

3. The method of claim 2, wherein the cryoprotectant agent is at least one of dimethyl sulfoxide (DMSO), methanol, butanediol, propanediol, polyvinylpyrrolidone, glycerol, hydroxyethyl starch, alginate, or a glycol.

4. The method of claim 2, wherein the cryoprotectant agent is DMSO.

5. The method of claim 2, wherein the cryopreservation solution comprises 10% to 20% (vol/vol) of the cryoprotectant agent.

6. The method of claim 1, wherein the processed tissue is removed from the processing vessel and soaked in a second cryopreservation solution for up to 2 hours prior to freezing, or wherein the tissue is soaked in a second cryopreservation solution for up to 2 hours prior to being placed in the processing vessel.

7. The method of claim 1, wherein resonant acoustic energy is applied for 10 to 60 minutes.

8. The method of claim 1, wherein the resonant acoustic energy exerts 10 to 60 times the energy of G-force (10-60 G) on the processing vessel and combination therein.

9. The method of claim 1, wherein the resonant acoustic energy has a frequency of 15 Hertz to 60 Hertz.

10. The method of claim 1, wherein the tissue, the processing solution, or both, are evaluated after application of the resonant acoustic energy to assess at least one characteristic.

11. The method of claim 1, wherein the tissue is frozen to a temperature of −80° C.

12. The method of claim 1, wherein the tissue is frozen in a solution comprising serum and 10-20% cryoprotectant agent.

13. The method of claim 12, wherein the cryoprotectant agent is DMSO.

14. A cryopreserved tissue product made according to the method of claim 1.

15. The cryopreserved tissue product of claim 14, wherein the cryopreserved tissue product retains at least 70% cell viability after two years in storage upon being thawed.

16. The cryopreserved tissue product of claim 14, wherein the cryopreserved tissue product retains at least 80% cell viability after two years in storage at −80° C. upon being thawed.

17. The cryopreserved tissue product of claim 14, wherein the cryopreserved tissue product retains at least 90% cell viability after two years in storage at −80° C. upon being thawed.

18. A method of cryopreserving a tissue, the method comprising soaking the tissue in a cryopreservation solution for up to 2 hours and then placing the tissue at freezing temperatures, thereby producing a cryopreserved tissue, wherein the tissue is cartilage tissue or osteochondral tissue.

19. A cryopreserved tissue product made according to the method of claim 18.
